(19) United States
(12) Patent Application Publication
(10) Pub. No.: US 2026/0070826 A1
(43) Pub. Date: Mar. 12, 2026

(54) MINERAL RECOVERY AND CHEMICAL PRODUCTION FROM PRODUCED WATER IN A GAS OIL SEPARATION PLANT

(71) Applicant: Saudi Arabian Oil Company, Dhahran (SA)

(72) Inventors: Khaled Nafee, Alajaweed (SA); Waleed Saeed, Dhahran (SA); Abdulaziz Y. AlAmmar, Dammam (SA)

(21) Appl. No.: 18/883,749

(22) Filed: Sep. 12, 2024

(51) Int. Cl. C02F 9/00; C01D 1/04; C01D 15/08; C01F 5/14; C01F 11/24; C02F 1/00; C02F 1/28; C02F 1/44; C02F 1/463; C02F 1/66; C02F 3/00; C02F 3/34; C02F 101/10; C02F 101/32; C02F 103/10; C25B 1/02; C25B 1/14; C25B 1/18; C25B 1/24; C25B 1/34; C25C 1/02; H01M 8/16

(52) U.S. Cl. CPC C02F 9/00; C01D 1/04; C01D 15/08; C01F 5/145; C01F 11/24; C25B 1/02; C25B 1/14; C25B 1/18; C25B 1/24; C25B 1/34; C25C 1/02; H01M 8/16; C02F 1/004; C02F 1/28; C02F 1/441; C02F 1/442; C02F 1/463; C02F 1/66; C02F 3/005; C02F 3/345; C02F 2101/101; C02F 2101/325; C02F 2103/10; C02F 2301/066

(57) ABSTRACT

A produced water stream in a GOSP is pretreated to remove total suspended solids, emulsified oil, total organic carbon, chemical organics and inorganics, and biodegradable matter. The pretreated produced water stream is further processed to remove hydrogen sulfide gas, which is split in an electrolysis cell to produce hydrogen, sulfur, and water. Following this, bromine gas is removed. The pretreated produced water stream, after the removal of hydrogen sulfide and bromine gas, is further treated using CO₂ to produce several minerals. The pretreated produced water stream, after mineral production, is desalinated to produce fresh water and a reject stream. Several valuable chemicals are produced from the reject stream. This process recovers valuable minerals and chemicals from a produced water stream in a GOSP.

### TECHNICAL FIELD

This disclosure relates to methods and systems of treating produced water in a gas oil separation plant (GOSP).

### BACKGROUND

Produced water is the water generated as a byproduct during oil and gas production. Produced water is rich in hydrocarbons, chemicals, salts, suspended solids, and other inorganic/organic content. Produced water varies considerably based on the geographic formation, type of hydrocarbon produced, and chemicals used during oil and gas operations. This variation makes the treatment of produced water difficult. Development of treatment technologies to extract valuable products from produced water is challenging. However, efficient, and cost-effective treatment methods can convert produced water from being a waste product to a useful and valuable resource.

### SUMMARY

The technology relates to mineral recovery and chemical production from produced water in a GOSP.

### BRIEF DESCRIPTION OF DRAWINGS

FIG. 1 is a block flow diagram of a process for produced water treatment.

FIG. 2 is schematic representation of a pretreatment system for produced water treatment.

FIG. 3 is a schematic representation of mineral mining from a pretreated produced water using captured CO₂ in a GOSP.

FIG. 4 is a schematic representation of mineral mining from a pretreated produced water stream with a high concentration of divalent and multivalent ions.

FIG. 5 is a schematic representation of a desalination process and chemical production from the reject brine.

FIG. 6 is a schematic representation of the integrated process for pretreating produced water and recovering minerals and chemicals from the pretreated produced water.

FIG. 7 is a schematic representation of the energy integration in the produced water treatment system.

FIG. 8 is a process flow diagram of the integrated produced water treatment.

### DETAILED DESCRIPTION

Implementations described here provide an integrated system and method of treating a produced water stream in a GOSP. The produced water stream undergoes a sequence of pretreatment steps to remove emulsified oil, total suspended solids (TSS), and organic content resulting in a pretreated produced water stream. The pretreated produced after the pretreatment steps has a temperature in the range of 70-90° C. The pretreated produced water stream is cooled. H₂S is removed in a sustainable way, which results in the generation of hydrogen gas and sulfur. After the removal of H₂S, the pretreated produced water stream undergoes a mineral extraction process. After mineral extraction, the pretreated produced water is desalinated in a desalination unit. The desalination process produces a permeate stream and a reject stream. The permeate stream primarily includes fresh water with most of the total dissolved solids (TDS) removed. The reject stream of the desalination process undergoes further treatment to recover several chemicals. Thus, the process described here recovers valuable minerals and chemicals from the produced water stream. In addition, the integrated process is operated in an energy efficient manner by reusing a portion of the permeate or reject stream as a cooling medium in a heat exchanger, which is used for cooling the pretreated produced water.

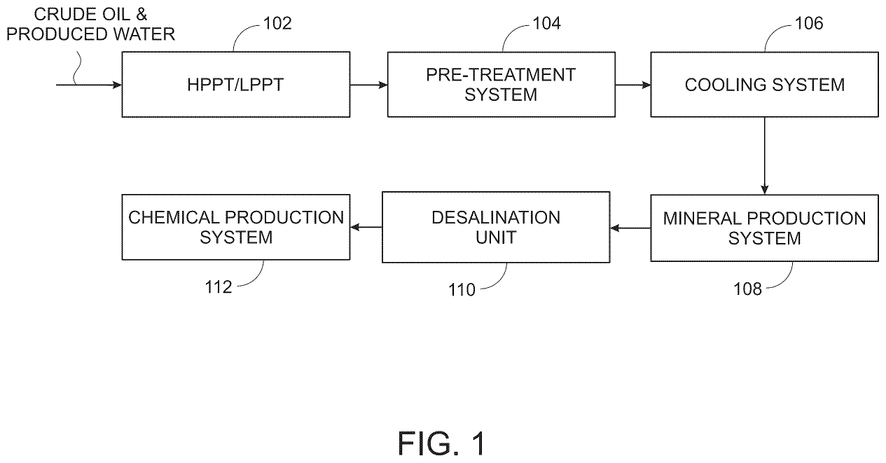

FIG. 1 is a block flow diagram of a process for produced water treatment. During hydrocarbon production from a subterranean formation, a mixture of crude oil and produced water flows through a production well. At block 102, a high pressure production trap (HPPT) and a low pressure production trap (LPPT) separate the crude oil and produced water from the mixture based on the density differences. A flow control equipment, which includes pumps and valves flows the produced water through a pipeline to the pre-treatment system located downstream of the HPPT and LPPT. The produced water includes large oil droplets, TSS, emulsified oil, chemicals, dissolved gases such as H₂S, organic content, hardness containing minerals, and TDS.

At block 104, the pre-treatment system treats the produced water by a sequence of steps resulting in pretreated produced water. The pre-treatment system can include an electrocoagulation (EC) unit, microbial fuel cell, electrolysis cell, filtration unit, adsorption unit, hydroclone, walnut shell filter, induced gas floatation unit, and/or dissolved gas floatation unit. The primary pre-treatment step includes the removal of TSS and oil droplets, which is described in the following paragraphs. The oil droplets include large oil droplets and small emulsified oil droplets. Following the removal of TSS and oil droplets, a microbial fuel cell or electrolysis cell removes the total organic carbon (TOC) (described in the following paragraphs). TOC represents the dissolved organic carbon, particulate organic carbon, volatile organic carbon (VOC), and non-purgeable organic carbon in the produced water.

After the removal of TOC, a specialized bacteria removes the dissolved chemical organics (described in the following paragraphs). The removal of dissolved chemical organics is measured by a parameter known as the chemical oxygen demand (COD). COD is the measure of the amount of oxygen consumed from the produced water to oxidize the organic matter chemically.

In some implementations, after the removal of dissolved chemical organics, the specialized bacteria remove the biodegradable organisms (described in the following paragraphs). The removal of biodegradable organisms is measured by a parameter known as the biological oxygen demand (BOD). BOD is the measure of the amount of oxygen consumed by bacteria and microorganisms in the produced water, while they decompose organic matter under aerobic conditions. In some implementations, specialized bacteria are incorporated into the produced water which can survive high salinity environments.

At block 106, the cooling system reduces the temperature of the pretreated produced water, resulting in a cooled pretreated produced water. In some implementations, the cooling system includes heat exchangers, evaporative cooling, or cooling towers.

At block 108, the mineral production system extracts minerals from the cooled pretreated produced water. In some implementations, the mineral production system includes a fuel cell, electrolysis cell, electrochemical cell membrane, electrolyzer, absorption unit, precipitation unit, filtration unit, and nanofiltration. A sequence of extraction steps is followed in the mineral production system to recover several valuable minerals from the cooled pretreated produced water. In some implementations, the minerals and or/gases extracted include calcium, strontium, lithium, magnesium, sodium, sulfur, oxygen, and hydrogen. The sequence of extraction steps depends on the amount of mineral content in the produced water. The amount of mineral content in the produced water depends on the geological formation, formation brine, and chemicals used during the production process.

At block 110, the desalination system desalinates the cooled pretreated produced water which is depleted of several minerals. The desalination process removes TDS from the cooled pretreated produced water. In some implementations, the desalination system implements a membrane separation process to remove TDS. The membrane separation process is performed by a membrane that is a component of the desalination system. The membranes include reverse osmosis (RO) membrane, high-pressure RO (HP-RO), ultrahigh-pressure RO (UHP-RO), nanofiltration (NF), microfiltration (MF), or ultrafiltration (UF) membrane. The membrane-based process can withstand a temperature of about 40-60° C.

In some implementations, the desalination unit implements a thermal based separation process to remove TDS. The thermal based separation process is performed by a multi-stage distillation (MED), multi-effect flash (MSF), or mechanical vapor compression (MVC). The thermal based process can withstand a temperature of about 70-90° C. The desalination process removes the remaining TDS from the cooled pretreated produced water to produce a permeate stream and a reject stream. Based on the efficiency of the desalination process, the permeate stream can include about 97-99% pure water. The reject stream, also referred to as concentrated brine, includes several chemicals and salts. In some implementations, the permeate stream and/or the reject stream are recycled to be used as a cooling medium for a heat exchanger in the cooling system at block 106.

At block 112, the chemical production system further treats the reject stream from the desalination unit. In some implementations, the chemical production unit includes an electrolyzer, an electrochemical cell, a precipitation unit, or a filtration unit. In some implementations, the chemicals produced in the chemical production unit are used as a reagent in the mineral production unit.

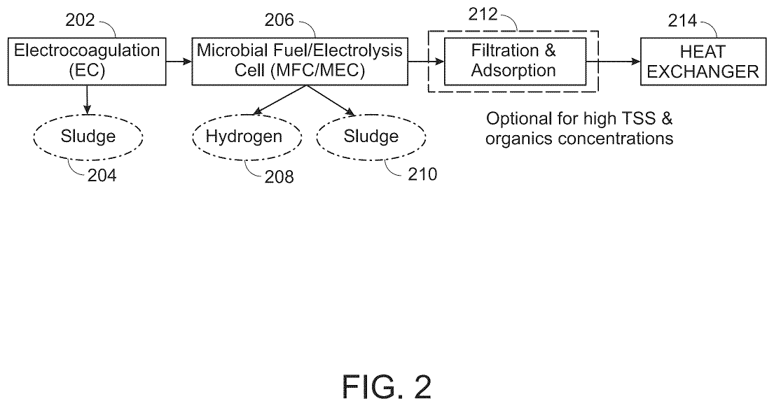

FIG. 2 is schematic representation of a pretreatment system for produced water treatment-block 104 from FIG. 1. The produced water flowing from a HPPT and LPPT of a GOSP includes contaminants such as oil droplets, TSS, dissolved organics, dissolved gases, TDS, and microorganisms. The produced water is treated to remove several of these contaminants. The treatment process depends on the nature and quantity of the contaminants. The contaminants found in produced water depend on the geological formation, formation brine in the reservoir, and chemicals used for the hydrocarbon production process. For example, a high salinity produced water (salinity greater than 100,000 ppm of TDS) with a high amount of TSS and dissolved organics will need additional filtration and adsorption in the treatment steps.

At block 202, an electrocoagulation (EC) unit treats the produced water. EC is a treatment technique that breaks down a stable emulsion or neutralizes the TSS in produced water by using metal ions released from a sacrificial anode. The EC unit includes two electrodes, an anode, and a cathode. When an electric current is applied to the electrodes, an electrochemical process takes place that includes oxidation at the cathode and reduction in the water phase. The electrochemical process results in the formation of agglomerates. In some implementations, the agglomerates float to the top and are removed using a filter. In some implementations, the agglomerates settle at the bottom of the EC unit and are removed. In some implementations, flocculation agents are added during the EC process. The EC unit is used to remove TSS, large oil droplets, and emulsified oil droplets. In some implementations, TSS and oil droplets are removed by a hydroclone, walnut filter, corrugated plate inceptor (CPI), induced gas floatation unit (IGF), or dissolved gas floatation unit (DGF). After the treatment in an EC unit, a sludge 204 is formed. The sludge 204 can be removed using a filter.

At block 206, a microbial fuel cell (MFC), a microbial electrolysis cell (MEC), or bentonite clay removes the TOC which includes dissolved organic carbon. A MFC includes two chambers, an anodic chamber and a cathodic chamber separated by a proton exchange membrane. The anodic chamber has anaerobic conditions. A nitrogen gas is used to maintain the anaerobic conditions. The dissolved organic carbon is fed into the anodic chamber, where the dissolved organic carbon acts as the substrate (food source) for the microorganisms. The MFC produces electrical energy using microorganisms as biocatalysts. As the microorganisms metabolize the substrate, the produced chemical energy is converted into electrical energy. This way the TOC in the produced water is removed from the produced water using the MFC. The MFC produces hydrogen gas 208 along with sludge 210. The resulting sludge 210 is siphoned off from the MFC.

In some implementations, a MEC is used to treat produced water. A MEC produces methane or hydrogen 208 and sludge 210 from the dissolved organic carbon in the produced water. The hydrogen 208 produced is used for various industrial processes such as syngas production or methanol or acetic acid production. The sludge 210 is filtered and removed from the MEC. In some implementations, the sludge 210 is mixed with calcium carbonate or other binders to solidify the waste, thereby creating a stable and non-hazardous solid material. The treated sludge 210 may be reused for soil amendment or construction materials.

In some implementations, a specialized bacteria that can survive in high saline conditions is incorporated into the produced water to remove dissolved chemical organics and biodegradable matter. A mixed culture of exoelectrigenic community can be utilized to catalyze the degradation of organics and biodegradable matter. Specially, geobacter anidireducens can perform well in produced water since it has high tolerance to salinity than other species of geobacter including sulfurresduces bacteria. An analytical parameter COD is used to measure the amount of oxygen consumed to remove the dissolved organics. Similarly, the analytical parameter BOD is used to measure the amount of oxygen consumed to remove the biodegradable matter.

In some implementations, at the end of block 206, the produced water is free of TSS and dissolved organics. However, in some cases the produced water may have a high content of TSS and organics. In this case, the produced water may need additional treatment such as the use of a filtration and adsorption unit.

At block 212, a filtration unit and adsorption unit treat the produced water with a high TSS and organic content. Depending on the size and nature of the dissolved organics a filtration unit can include microfiltration, nanofiltration, ultrafiltration, or ceramic filtration.

In some implementations, an adsorption unit includes activated carbon for removing dissolved organics from produced water. Activated carbon has a large surface area making it very effective for adsorption of organics and total petroleum products (TPH). In some implementations, the activated carbon surface is modified to adsorb specific contaminants such as metals. In some implementations, zeolites are used as the adsorption medium. The dissolved organics include benzene, toluene, chlorinated aromatics, phenols, chlorinated aliphatics, high molecular weight hydrocarbons. In some implementations, silica gel, ion exchange resins, and polymeric adsorbents are used to remove dissolved organics.

In some implementations, the pH of the produced water is lowered prior to the pretreatment step at block 212. The lowering of pH converts the dissolved organics into insoluble organics which helps with the removal of total petroleum hydrocarbons (TPH) by the adsorption media.

At block 214, a heat exchanger cools the pretreated produced water before the extraction of minerals. In some implementations, cooling of the pretreated produced water is done by multiple heat exchangers. In some implementations, multiple heat exchangers connected in series or parallel are used to cool the pretreated produced water. In some implementations, evaporative cooling or a cooling tower is used to cool the pretreated produced water.

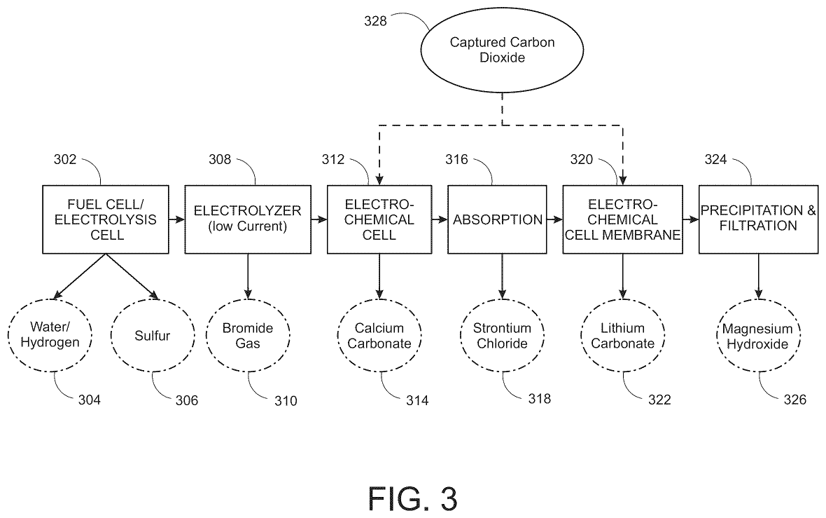

FIG. 3 is a schematic representation of mineral mining from a pretreated produced water using captured CO₂ in a GOSP.

At block 302, a fuel cell removes the dissolved hydrogen sulfide (H₂S) gas from the pretreated produced water by producing hydrogen, water, and sulfur from the H₂S. Fuel cell is an electrochemical cell that uses an oxidizer such as oxygen at the cathode as the driver of potential to produce water. In some implementations, H₂S is used as a fuel source. H₂S is usually dissolved in the pretreated produced water in the form of bisulfide (HS⁻), and to a lesser extent in the form of sulfide ions (S²⁻). The distribution of the HS⁻ and S²⁻ ions depends on the pH of the pretreated produced water. In some implementations, the pH of the pretreated produced water is increased to about 8.5-11 to maintain a higher concentration of HS⁻ ions. A higher concentration of HS⁻ ions in the pretreated produced water makes it easier to dissociate into water (H₂O), hydrogen 304, and sulfur 306 in the fuel cell

In some implementations, an electrolysis cell is used to produce hydrogen 304 and sulfur 306 from the dissolved H₂S in pretreated produced water. An electrolysis cell makes use of electrical energy to split a chemical species. For example, the electrolysis cell splits H₂S into hydrogen 304 and sulfur 306. An electrolysis cell uses an external source of electric current to drive the potential to produce hydrogen in the cathodic side of the electrolysis cell. The produced sulfur 306 is recovered and used in various industrial processes, such as manufacturing rubber, fertilizers, chemicals, and sulfuric acid. In some implementations, the hydrogen recovered can be used as a source for syngas production or methanol and acetic acid production.

At block 308, a low current electrolyzer receives the pretreated produced water, from which H₂S is removed. In implementations here, bromine gas (Br₂) 310 is produced by a selective electrochemical oxidation process at a low voltage. A low current electrolyzer is used because the potential required to form Br₂ is low (E⁰=1.068 V). The low current electrolyzer uses a graphite anode. In some implementations, the Br₂ production takes place before the mineral recovery process as the low current electrolyzer uses a low voltage. This enhances the production of Br₂.

At block 312, an electrochemical cell receives the pretreated produced water from block 308, from which bromine is recovered (removed). A CO₂ capture unit 328 supplies CO₂ to the electrochemical cell for the production of calcium in the form of calcium carbonate (CaCO₃) 314. The production of calcium in the form of CaCO₃ 314 occurs through a selective electrochemical process that utilizes CO₂ as a feed for the mineralization process. In some implementations, the selective electrochemical process uses a large amount of CO₂. Therefore, a continuous supply of CO₂ from the CO₂ capture unit 328 is received by the electrochemical cell. A pretreated produced water with calcium removed exits block 312.

At block 316, an adsorption unit receives the pretreated produced water that exits block 312. The adsorption unit includes an adsorbent material. In some implementations, the adsorption material includes nickel-iron ferromagnetic alloy, carbon, or ferrous oxide (Fe₃O₄) magnetic nanocomposite. The adsorbent material adsorbs strontium ions (Sr⁺²) from the pretreated produced water. This is followed by the addition of hydrochloric acid (HCl) to recover and precipitate the strontium ions in the form of SrCl₂ 318.

At block 320, an electrochemical cell membrane receives the pretreated produced water that exits block 316. In some implementations, lithium (Li) is extracted with high purity through a selective electrochemical membrane process. In some implementations, the electrochemical membrane process utilizes a highly selective proton exchange membrane (PEM), which allows Li to concentrate prior to precipitation by soda ash or phosphate. Li is recovered as lithium carbonate 322. CO₂ is obtained from the CO₂ capture unit 328 to form lithium carbonate 322. CO₂ is used to form a buffer solution to control the pH for either produced lithium phosphate or lithium carbonate via reaction R.1 to form bicarbonate (HCO₃⁻) or carbonate (CO₃²⁻) via reaction R2.

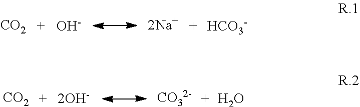

At block 324, a precipitation unit and filtration unit receive the pretreated produced water that exits block 320. Magnesium hydroxide (Mg(OH)₂) 326 is recovered by a precipitation process using sodium hydroxide (NaOH) via reaction R.3.

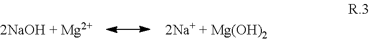

In some implementations, ammonium hydroxide is used to precipitate Mg(OH)₂. The Mg(OH)₂ 326 formed is filtered using a microfiltration membrane. In some implementations, the precipitation and filtration processes are conducted at a temperature of about 40-70° C.

The mineral extraction process sequence can vary based on the mineral concentration in the produced water. In some cases, if the magnesium concentration is high, a selective electrochemical process can be used instead of the precipitation method to selectively recover magnesium hydroxide before the recovery of lithium carbonate. In some implementations, lithium and strontium recovery processes are placed at the beginning of the mining process, if the concertation of calcium and magnesium are lower compared to lithium and strontium.

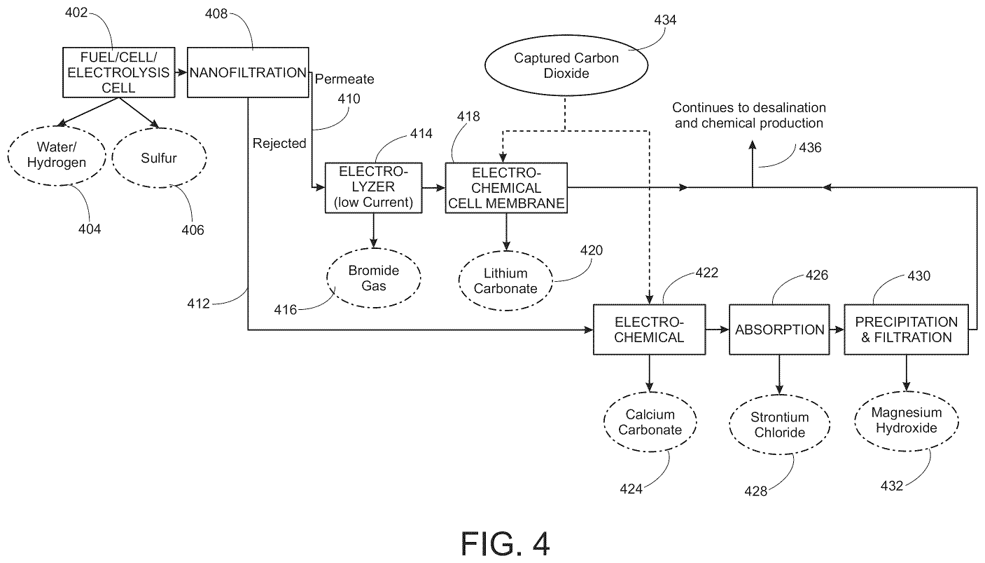

FIG. 4 is a schematic representation of mineral mining from a pretreated produced water stream with a high concentration of divalent and multivalent ions. An electrolysis cell 402 receives the pretreated produced water, where water, hydrogen 404, and sulfur 406 are formed. In some implementations, the concentration of divalent ions and multivalent ions is greater than 30,000 ppm. In some implementations, the concentration of divalent ions is greater than 25,000 ppm and multivalent ions is greater than 5,000 ppm in the pretreated produced water. These ions include strontium, calcium, magnesium, and sulfate. The divalent and multivalent ions can be removed using a nanofiltration (NF) membrane 408. The NF membrane 408 produces a nano-permeate stream 410 and a nano-reject stream 412. Smaller ions such as lithium passes through the NF membrane and are found in the nano-permeate stream 410. The larger divalent and multivalent ions are captured in the nano-reject stream 412.

In some implementations, the nano-permeate stream 410 is acidified by the addition of HCl and oxidized with chlorine (Cl₂) to liberate bromide ions (Br⁻). The Br⁻ ions are converted to Br₂ 416 via reaction R.4.

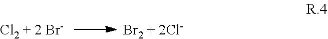

In some implementations, a low current electrolyzer 414 is used to produce Br₂ 416 as described in FIG. 3. Further, Br₂ is captured and condensed into a liquid form by a series of cooling chambers and condensers. In some implementations, the condensed Br₂ liquid is purified further and separated from other impurities using various methods such as distillation and solvent extraction to increase the recovery and purity of liquid Br₂. The nano-permeate stream further flows into an electrochemical cell membrane 418 to recover lithium. CO₂ from the CO₂ capture unit 434 is used to recover lithium as lithium carbonate 420.

The divalent and multivalent ions such as magnesium, strontium, and calcium are found in the nano-reject stream 412. The nano-reject stream 412 flows into an electrochemical cell membrane 422 where calcium is recovered as CaCO₃ 424. A selective electrochemical process utilizes CO₂ as a feed from the CO₂ capture unit 434 for the mineralization process to produce CaCO₃ 424.

The nano-reject stream 412 flows into an absorption unit 426, where strontium is recovered as strontium chloride 428. The absorbent used is hydrochloric acid. The nano-reject stream 412 is further processed in a precipitation and filtration unit 430, where magnesium is recovered as Mg(OH)₂ 432. In some implementations, Mg(OH)₂ is precipitated using NaOH. In some implementations, Mg(OH)₂ is precipitated using ammonium hydroxide. After mineral recovery, both the nano-permeate stream 410 and the nano-reject stream 412 flow as a combined stream 436 to the desalination unit.

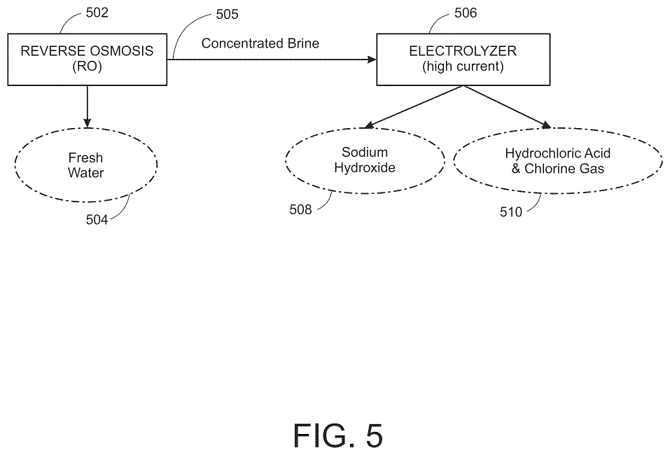

FIG. 5 is a schematic representation of a desalination process and chemical production from the reject brine. After the mineral recovery process, the pretreated produced water is cooled down to about 40-60° C. and a desalination unit 502 receives the pretreated produced water. In some implementations, the pretreated produced water is cooled down to below 40° C. The pretreated produced water is cooled by a heat exchanger which uses ground water at 5-20° C. as the cooling media. In some implementations, the desalination unit 502 includes a RO membrane, UHP-RO membrane, or osmotically assisted RO. In cases where the TDS of the pretreated produced water after mineral recovery is higher than 100,000 ppm, a UHP-RO is used for desalination. The advantage of implementing a membrane based process in the desalination unit post mineral recovery is that it minimizes fouling and scaling of the membrane.

The desalination process produces a permeate stream which is fresh water 504 and a reject stream which is concentrated brine 505. Depending on the efficiency of the membrane used in the desalination unit 502, the concentrated brine 505 includes about 90-99% of the TDS after desalination. A high current electrolyzer 506 receives the concentrated brine 505. The electrolyzer produces NaOH 508 and HCl 510. During the production of HCl 510, chlorine gas (Cl₂) is also produced. In some implementations, the electrolyzer produces H₂ and O₂ gases.

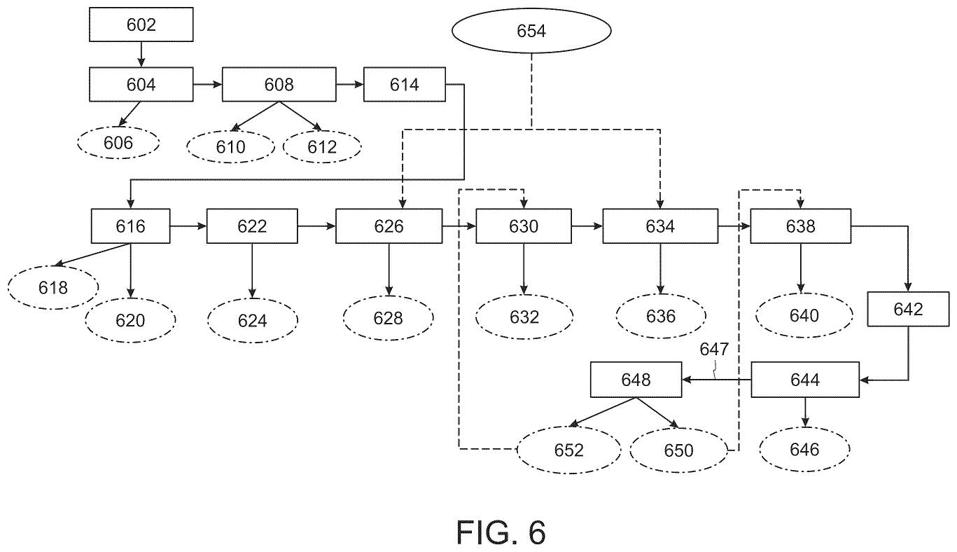

FIG. 6 is a schematic representation of the integrated system for pretreating produced water and recovering minerals and chemicals from the pretreated produced water. Produced water 602 flows from a HPPT and LPPT in a GOSP. An EC unit 604 treats the produced water 602 to remove oil droplets, emulsions, and TSS. Residual sludge 606 is produced as a result of the electrocoagulation process.

A MFC or MEC 608 further treats the produced water 602 to remove the dissolved organic carbon. In some implementations, bentonite clay is used to remove the dissolved organic carbon. The MFC and MEC 608 produce hydrogen 610 and sludge 612. At this stage, the produced water 602 is free of TSS, oil droplets, emulsified oil, dissolved organic carbon, dissolved chemical organics, and biodegradable matter. A heat exchanger 614 cools the pretreated produced water. In some implementations, the heat exchanger 614 uses an output stream from the desalination unit for the cooling process. The pretreated produced water is cooled to about 40-60° C.

The cooled and pretreated produced water is fed into a fuel cell 616. The fuel cell 616 splits the dissolved H₂S in the pretreated produced water into hydrogen 618 and sulfur 620 as explained in FIG. 3. The pretreated produced water, depleted of dissolved H₂S is further processed in a low current electrolyzer 622 to produce Br₂ 624. In some implementations, the low current electrolyzer 622 is placed ahead of the mineral production system to recover large volumes of Br₂, as the current required to recover Br₂ is low.

After the recovery of Br₂, the pretreated produced water undergoes mineral extraction. An electrochemical cell 626 membrane processes the pretreated produced water to recover calcium in the form of CaCO₃ 628. CO₂ is utilized for the formation of CaCO₃ 628. The CO₂ is sourced from a carbon capture unit 654. Following the recovery of calcium, the pretreated produced water is flowed into an absorption unit 630. In the absorption unit 630, strontium is recovered in the form of strontium chloride 632. HCl is used for the production of strontium chloride 632. The HCl is obtained from an electrolyzer 648 which is placed downstream of the desalination unit 644. The electrolyzer 648 produces HCl along with other chemicals.

After the recovery of strontium, an electrochemical cell membrane 634 receives the pretreated produced water. The electrochemical cell membrane 634 is used to recover lithium in the form of lithium carbonate 636. CO₂ is utilized for the formation of lithium carbonate 636. The CO₂ is sourced from a carbon capture unit 654. After the recovery of lithium, a precipitation and filtration unit 638 receives the pretreated produced water to recover Mg(OH)₂ 640. To recover Mg(OH)₂ 640, NaCl is used as a precipitating agent. The NaCl 650 is obtained as a byproduct of an electrolysis reaction in the electrolyzer 648. The NaCl is recycled to the precipitation and filtration unit 638, thereby optimizing the mineral recovery process. In some implementations, a selective extraction of calcium, strontium, and magnesium before the extraction of lithium can enhance the overall process efficiency and mineral recovery. In some implementations, the minerals can be extracted in different process orders.

After the mineral recovery process, a heat exchanger 642 cools the pretreated produced water. In some implementations, multiple heat exchangers connected in series or parallel are used for the cooling process. In some implementations, evaporative coolers are used for the cooling process. After cooling, a desalination unit 644 removes the remaining TDS from the pretreated produced water. In some implementations, the desalination unit 644 includes an RO membrane, UHP-RO membrane, NF membrane, UF membrane, or osmotically assisted RO. In some implementations, a multi-stage high pressure RO membrane is used with pressure exchange systems to minimize energy consumption of concentrating the retentate stream of the desalination process.

The desalination unit 644 produces a permeate stream 646 and a reject stream 647 (reject stream is also known as retentate stream). The permeate stream 646 is primarily fresh water. The reject stream 647 is concentrated brine, from which chemicals are produced. The reject stream 647 is flowed into an electrolysis cell 648. An electrolysis reaction produces NaOH 650, HCl 652, and chlorine gas. In some implementations, a multi-stage high pressure RO membrane is used with pressure exchange systems to enhance the efficiency of the electrolysis cell 648. The HCl produced in the electrolysis cell 648 is recycled to the absorption unit 630 for the production of strontium chloride 632. The NaOH 650 is recycled to the precipitation and filtration unit 638 for the production of Mg(OH)₂ 640.

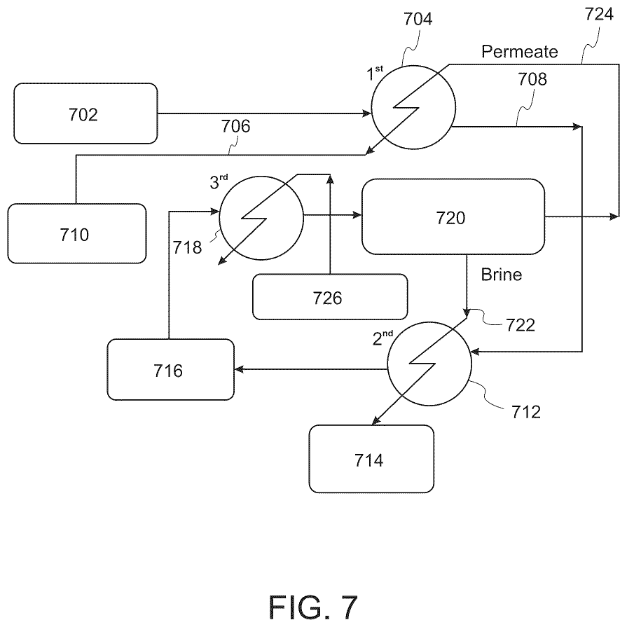

FIG. 7 is a schematic representation of the energy integration in the produced water treatment system. A pretreatment unit 702 treats the produced water in a GOSP. In some implementations, the pretreatment unit includes a EC unit, a MFC, and/or a MEC unit. A first heat exchanger 704 cools the pretreated produced water exiting the MFC or the MEC. The first heat exchanger 704 uses a permeate stream 724 as a cooling medium. The permeate stream 724 flows from the desalination unit 720. In some implementations, the reject stream 722 is used as the cooling media for first heat exchanger 704. In some implementations, the pretreated produced water is cooled down to about 40-60° C.

The advantages of this integration are not only limited to cooling the stream exiting stream from the MEC/MFC but also enhances the permeate stream and reject stream quality for later processing. For example, the permeate stream is usually desired at a higher temperature (50° C.-65° C.) to be used in the GOSP for desalting the crude oil. In addition, a higher temperature of the permeate stream prevents precipitation of high molecular weight compounds, which aids in improving the overall desalting process efficiency. While the reject stream, which is primarily concentrated brine, would be more efficient at a higher temperature for the alkaline electrolyzer in the chemical production unit 714. At a higher temperature, the conductivity and the reaction rate of the concentrated brine increases, which enhances the overall electrolyzer efficiency. The increased electrolyzer efficiency improves the production of NaOH.

After the cooling process, the permeate stream 724 which is used to cool the first heat exchanger 704 is further collected as fresh water in a fresh water tank 710. After the cooling process, a second heat exchanger 712 further cools the effluent pretreated produced water 708 from the first heat exchanger 704. In some implementations, the second heat exchanger 712 uses the reject stream 722 from the desalination unit 720 as the cooling media. After cooling, a first portion of the effluent pretreated produced water 708 is flowed into a chemical production unit 714. A second portion of the effluent pretreated produced water 708 is flowed into the mineral recovery unit 716.

In the mining recovery unit, several minerals such as sulfur, calcium, magnesium, lithium, and strontium are removed from the second portion of the effluent pretreated produced water 708. After mineral recovery, a third heat exchanger 718 further cools the second portion of the effluent pretreated produced water 708. A groundwater source 726 is used as the cooling media for the third heat exchanger 718. The effluent after cooling by the third heat exchanger 718 is processed in a desalination unit 720. The desalination unit 720 produces a permeate stream 724 and a reject stream 722. The permeate stream 724 and the reject stream 722 are used as the cooling media for one or more heat exchangers integrated in the GOSP.

Table 1 and Table 2 represent a mass and energy balance for the integrated produced water treatment system, respectively. In this example, a plant with 40,000 barrels per day (BPD) capacity was used in calculating the mass and energy balance. The data for the energy consumption for each unit was considered. The energy recovery calculation for the integrated system is represented in Table 3. Table 3 shows that the use of the integrated cooling process results in a 26.1% (of the entire system energy input) energy recovery.

TABLE 1
Mass balance calculation for the integrated
produced water treatment system

| | Energy | | Weight | | Energy |
|---|---|---|---|---|---|
| Unit Name | (kWh/kg) | | (Kg/day) | | (kWh/day) |
| Fuel Cell | 50 | | 400 | | 20000 |
| Electrolyzer | 1.1 | | 5695.34364 | | 6264.878004 |
| Stage 1 - Br₂ | | | | | |
| Electrolyzer | 1.9 | | 185123.2172 | | 351734.1127 |
| Stage 2 - HCl | | | | | |
| Electrolyzer | 1.7 | | 105201.8346 | | 178843.1189 |
| Stage 2 - NaOH | | | | | |
| Absorption - Sr₂ | 1.07 | | 1772.430219 | | 1896.500334 |
| RO | 3 | {kwh/m3) | 3927.822 | m3 | 11783.466 |
| MEC | 0.2 | {kwh/m3) | 445153.296 | m3 | 785.5644 |

TABLE 2
Energy balance calculation for the integrated
produced water treatment system

| | Energy | |
|---|---|---|
| Unit Name | consumption | Units |
| Electrocoagulation | 54439.63 | kWh/day |
| Fuel Cell | 20000 | kWh/day |
| Electrochemical Cell | 3273.185 | kWh/day |
| Electrolyzer Stage 1 | 6264.878004 | kWh/day |
| Electrolyzer Stage 2 | 530577.2315 | kWh/day |
| Absorption | 1896.500334 | kWh/day |
| Reverse Osmosis | 11783.466 | kWh/day |
| Total Energy Consumption | 628234.8909 | kWh/day |
| Total Energy Consumption | 628.2348909 | MWh/day |
| Power | 104.7058151 | MW |

TABLE 3
Cooling energy recovered in the integrated
produced water treatment system

| | | | |
|---|---|---|---|
| v (m3/d) | 6360 | Converted (s) | 0.07361111 |
| Cp (J/kg · K) | 4148 | | |
| Density (kg/m³) | 1000 | | |
| Old Delta_T (K) | 30 | | |

| | | | Barrel of oil | |
|---|---|---|---|---|
| Total cooling energy Q = mCp(Th-Tc) | | | equivalent (BOE) | |
| Q (W) | Q (Wh/d) | Q (kWh/d) | BOE/d | $/BOE |
| 9239666.667 | 221752000 | 221752 | 130.4423529 | 6522.117647 |

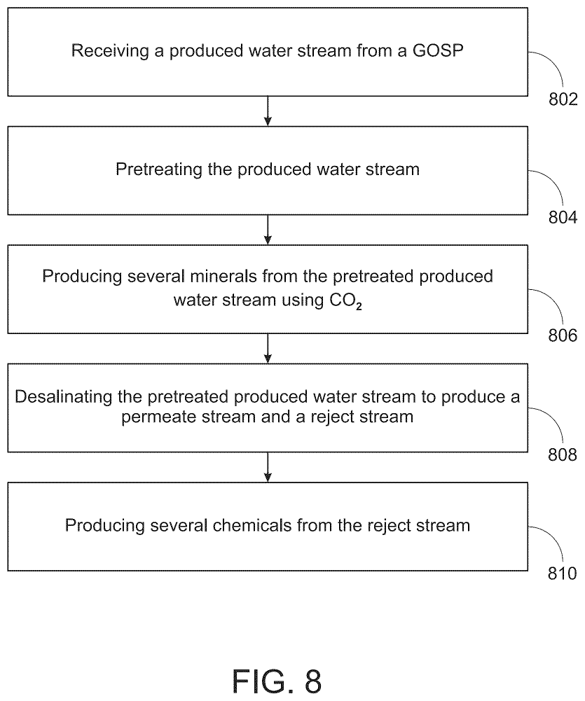

FIG. 8 is a process flow diagram of the integrated produced water treatment. At block 802, a HPPT and LPPT receives the produced water in a GOSP. The contaminants in the produced water depend on the geological formation, formation brine, and chemicals used during hydrocarbon production. The produced water includes large oil droplets, emulsified oil droplets, TSS, dissolved organic carbon, dissolved chemical organics, dissolved gases, and TDS.

At block 804, a pretreatment unit treats the produced water to remove large oil droplets, emulsified oil droplets, and TSS using a electrocoagulation unit. In some implementations, a hydroclone unit, walnut filter, corrugated plate inceptor (CPI), induced gas floatation unit (IGF), or dissolved gas floatation unit (DGF) are used to remove oil droplets and TSS. The dissolved organic carbon in the produced water is removed using a MFC, MEC, or bentonite clay. The dissolved organic chemicals and biodegradable matter are removed using a specialized bacteria that is incorporated in the produced water. After the pretreatment process, the resulting pretreated produced water is cooled down and flowed into the mineral extraction unit.

At block 806, the mineral extraction unit receives the pretreated produced water. In some implementations, prior to mineral extraction from the pretreated produced water, Br₂ is produced using a low current electrolyzer. In some implementations, a fuel cell is used to dissociate dissolved H₂S into H₂/H₂O and sulfur. In some implementations, the pH of the pretreated produced water is increased to maintain a higher concentration of HS⁻. The higher concentration of HS-ions makes it easier to dissociate dissolved H₂S into H₂/H₂O and sulfur. After the recovery of Br₂, H₂, and sulfur, the pretreated produced water undergoes a mineral recovery process. The minerals can be recovered in any process order. In some implementations, the minerals recovered include calcium, strontium, lithium, and magnesium. During the mineral recovery process, CO₂ from the carbon capture unit is utilized for the recovery of calcium and lithium.

At block 808, a cooling system cools the pretreated produced water after mineral recovery. The pretreated produced water is further desalinated. The desalination process produces a permeate stream and a reject stream. In some implementations, the desalination unit includes an RO membrane, UHP-RO membrane, NF membrane, UF membrane, or osmotically assisted RO. The permeate stream includes fresh water and is collected in a tank. In some implementations, the permeate stream is used as a cooling media for multiple heat exchangers. The reject stream contains most of the TDS and is primarily concentrated brine. In some implementations, the reject stream is used as a cooling media for multiple heat exchangers.

At block 810, a high current electrolyzer receives the reject stream to produce useful chemicals such as NaOH, HCl, and Cl₂ gas. The NaOH is recycled to the mineral extraction unit to precipitate magnesium hydroxide. The HCl is recycled to the mineral extraction unit to produce strontium chloride.

### Examples

Certain aspects of the subject matter described here can be implemented as a method in a GOSP. A produced water stream is pretreated in a GOSP resulting in a pretreated produced water stream. H₂S is removed from the pretreated produced water stream. From the removed H₂S, hydrogen, water, and sulfur are produced by an electrolysis cell or a fuel cell. After producing H₂, H₂O, and S, the pretreated produced water stream is desalinated to form a permeate stream and a reject stream.

An aspect combinable with any other aspect includes the following features. The pretreatment of the produced water includes removing TSS, emulsified oil, TOC, COD, and BOD.

An aspect combinable with any other aspect includes the following features. The method further includes removing TSS and emulsified oil by an EC process, MEC, MFC, or a bentonite clay. Further, the excess TOC is removed by a filtration unit and an adsorption unit. COD and BOD are removed by a bacteria.

An aspect combinable with any other aspect includes the following features. The method further includes removing H₂S by controlling the pH of the pretreated produced stream.

An aspect combinable with any other aspect includes the following features. The method includes the production of Br₂ by an electrochemical oxidation process, after the removal of H₂S from the pretreated produced water stream.

An aspect combinable with any other aspect includes the following features. The method includes the production of several minerals from the pretreated produced water stream using CO₂. An electrochemical cell membrane is used to produce calcium. After the production of calcium, an absorption unit is used to produce strontium. After the production of strontium, an electrochemical cell membrane is used to produce lithium. After the production of lithium, a precipitation and a filtration unit are used to produce magnesium.

An aspect combinable with any other aspect includes the following features. The method includes the cooling of the pretreated produced water to a temperature below 40° C. by a heat exchanger prior to desalinating. The desalination process uses a RO membrane and an UHP-RO membrane.

An aspect combinable with any other aspect includes the following features. The method includes the production of several chemicals from the reject stream. An electrolyzer is used to produce NaOH and HCl. Chlorine gas is recovered from the electrolyzer after the production of NaOH and HCl.

An aspect combinable with any other aspect includes the following features. The method includes the determination of a concentration of divalent and multivalent ions, greater than 30,000 ppm, after the removal of H₂S. On the determination that the divalent ions concentration is at least 25,000 ppm and the multivalent ions concentration is at least 5,000 ppm, the pretreated produced water stream is filtered using a nanofiltration unit placed downstream of the electrolysis cell or fuel cell. This results in the production of a nano-permeate stream and a nano-reject stream.

An aspect combinable with any other aspect includes the following features. The method further includes acidification of the nano-permeate stream with HCl to produce Br₂ using a low current electrolyzer. The method further includes condensation of Br₂ into a liquid form using cooling chambers and condensers. Lithium carbonate is recovered from the nano-permeate stream using an electrochemical process. Calcium carbonate is recovered from the nano-reject stream using an electrochemical process. Strontium chloride is recovered from the nano-reject stream by absorption. Magnesium hydroxide is recovered from the nano-reject stream by precipitation.

An aspect combinable with any other aspect includes the following features. The method further includes flowing the permeate stream and the reject stream, after desalination, as a cooling media for an output stream from a MEC or a MFC.

Certain aspects of the subject matter described here can be implemented as a method in a GOSP. The produced water in a GOSP is pretreated resulting in a pretreated produced water stream. Br₂ gas is produced from the pretreated produced water stream to form a permeate stream and a reject stream. Several chemicals are produced from the reject stream.

An aspect combinable with any other aspect includes the following features. The method further includes removing H₂S from the pretreated produced water stream before producing Br₂. Hydrogen, water, and sulfur are produced from the H₂S by an electrolysis cell or a fuel cell.

An aspect combinable with any other aspect includes the following features. The method further includes using a CO₂ stream to produce several minerals from the pretreated produced water stream.

An aspect combinable with any other aspect includes the following features. The method where the production of several minerals includes producing calcium by an electrochemical cell membrane, producing strontium by an absorption unit, producing lithium by an electrochemical cell membrane, and producing magnesium by a precipitation and a filtration unit.

An aspect combinable with any other aspect includes the following features. The method includes producing several chemicals from the reject stream, where NaOH and HCl are produced using an electrolyzer. Chlorine gas is recovered from the electrolyzer.

Certain aspects of the subject matter described here can be implemented as a method in a GOSP. A produced water stream is received from a GOSP. The produced water stream is pretreated to remove TSS, emulsified oil, TOC, COD, and BOD, resulting in a pretreated produced water stream. Several minerals are produced from the pretreated produced water stream using CO₂. After the production of several minerals from the pretreated produced water stream, the pretreated produced water stream is desalinated to form a permeate stream and a reject stream. Several chemicals are produced from the reject stream.

An aspect combinable with any other aspect includes the following features. The method includes removing H₂S from the pretreated produced water stream before producing several minerals. Hydrogen, water, and sulfur are produced by an electrolysis cell or a fuel cell from the removed H₂S stream. Further, bromine gas is produced by an electrochemical oxidation process.

An aspect combinable with any other aspect includes the following features. The method includes producing several minerals, such as calcium, strontium, lithium, and magnesium.

An aspect combinable with any other aspect includes the following features. The method includes producing several chemicals from the reject stream. The several chemicals include NaOH, HCL, and chlorine gas which are produced by an electrolyzer.

An implementation described here provides an integrated and optimized system and method to treat produced water. The process described here transforms produced water from being a wastewater to a valuable resource. The integrated system utilizes a method of pretreating produced water to remove TSS, oil droplets, dissolved organic carbon, dissolved chemicals, and biodegradable matter.

The pretreated produced water is used to extract minerals and valuable chemicals. Implementations described here provide a sustainable source of hydrogen, bromine, and chlorine gases. The minerals recovered from the pretreated produced water include sulfur, calcium, strontium, lithium, and magnesium. Further valuable chemicals such as NaOH and HCl are recovered from the pretreated produced water. Since most of the TDS is removed in the form of minerals, the energy required for the desalination process to produce fresh water is minimized. Using the integrated process described above, the process recovers about 26% of the total energy. Further, CO₂ from the carbon capture unit is utilized in the process, thereby reducing the carbon foot print.

Other implementations are also within the scope of the following claims.

1. A method comprising:
pretreating a produced water (PW) stream in a gas oil separation plant (GOSP), resulting in a pretreated PW stream;
removing hydrogen sulfide (H₂S) from the pretreated PW stream;
producing, from the removed H₂S, hydrogen (H₂), water (H₂O), and sulfur(S) by an electrolysis cell or a fuel cell;
after producing H₂, H₂O, and S, desalinating the pretreated PW stream to form a permeate stream and a reject stream; and
producing a plurality of chemicals from the reject stream.

2. The method of claim 1, wherein pretreating the PW stream comprises removing total suspended solids (TSS), removing emulsified oil, removing total organic carbon (TOC), removing chemical oxygen demand (COD), and removing biological oxygen demand (BOD).

3. The method of claim 2, further comprising:
removing TSS and emulsified oil by an electrocoagulation process (EC);
removing TOC by a microbial electrolysis cell (MEC), microbial fuel cell (MFC), or a bentonite clay;
further removing an excess TOC by a filtration unit and an adsorption unit; and
removing COD and BOD by a bacteria.

4. The method of claim 1, further comprising, removing H₂S by controlling a pH of the pretreated PW stream.

5. The method of claim 1, further comprising, after removing H₂S from the pretreated PW stream, producing bromine gas (Br₂) by an electrochemical oxidation process.

6. The method of claim 1, further comprising producing a plurality of minerals from the pretreated PW stream using a carbon dioxide (CO₂) stream comprises:
using an electrochemical cell membrane to produce calcium;
after producing calcium, using an absorption unit to produce strontium;
after producing strontium, using an electrochemical cell membrane to produce lithium; and
after producing lithium, using a precipitation and a filtration unit to produce magnesium.

7. The method of claim 1, further comprising cooling the pretreated PW to a temperature below 40° C. by a heat exchanger prior to desalinating, wherein desalinating comprises a reverse osmosis (RO) membrane and an ultra-high pressure RO (UHP-RO) membrane.

8. The method of claim 1, wherein producing the plurality of chemicals from the reject stream comprises:
using an electrolyzer to produce sodium hydroxide (NaOH) and hydrochloric acid (HCl); and
recovering, from the electrolyzer, chlorine gas (Cl₂) after producing the NaOH and HCl.

9. The method of claim 1, further comprising:
after removing H₂S, determining that a concentration of divalent ions and multivalent ions is higher than 30,000 ppm; and
in response to determining that the concentration of divalent ions of at least 25,000 ppm and multivalent ions of at least 5,000 ppm, filtering the pretreated PW stream, using a nanofiltration unit downstream of the electrolysis cell or fuel cell, to produce a nano-permeate stream and a nano-reject stream.

10. The method of claim 9, further comprising:
acidifying the nano-permeate stream with HCl to produce Br₂ using a low current electrolyzer;
condensing Br₂ into a liquid form by using cooling chambers and condensers;
recovering, from the nano-permeate stream, lithium carbonate by an electrochemical process;
recovering, from the nano-reject stream, calcium carbonate by an electrochemical process;
recovering, from the nano-reject stream, strontium chloride, by absorption; and
recovering, from the nano-reject stream, magnesium hydroxide by precipitation and filtration.

11. The method of claim 1, further comprising flowing the permeate stream and the reject stream after desalination, as a cooling media for an output stream from a MEC or a MFC.

12. A method comprising:
pretreating a produced water (PW) stream in a gas oil separation plant (GOSP), resulting in a pretreated PW stream;
producing bromine gas (Br₂) from the pretreated PW stream;
after producing bromine gas (Br₂) from the pretreated PW stream, desalinating the pretreated PW stream to form a permeate stream and a reject stream;
producing a plurality of chemicals from the reject stream.

13. The method of claim 12, further comprising, before producing Br₂ from the pretreated PW stream:
removing hydrogen sulfide (H₂S) from the pretreated PW stream; and
producing hydrogen (H₂), water (H₂O), and sulfur(S), from the removed H₂S, by an electrolysis cell or a fuel cell.

14. The method of claim 12, further comprising, using a carbon dioxide (CO₂) stream to produce a plurality of minerals from the pretreated PW stream.

15. The method of claim 14, wherein producing the plurality of minerals comprises:
producing calcium by an electrochemical cell membrane;
producing strontium by an absorption unit;
producing lithium by an electrochemical cell membrane; and
producing magnesium by a precipitation and a filtration unit.

16. The method of claim 12, wherein producing a plurality of chemicals from the reject stream comprises:
producing sodium hydroxide (NaOH) and hydrochloric acid (HCl) by an electrolyzer; and
recovering, chlorine gas (Cl₂), from the electrolyzer.

17. A produced water treatment method comprising:
receiving a produced water (PW) stream from a gas oil separation plant (GOSP);
pretreating the PW stream to remove total suspended solids (TSS), emulsified oil, total organic carbon (TOC), chemical oxygen demand (COD), and biological oxygen demand (BOD), resulting in a pretreated PW stream;
producing a plurality of minerals from the pretreated PW stream using a carbon dioxide (CO₂) stream;
after producing the plurality of minerals from the pretreated PW stream, desalinating the pretreated PW stream to form a permeate stream and a reject stream;
producing a plurality of chemicals from the reject stream.

18. The method of claim 17, further comprising, before producing a plurality of minerals:
removing hydrogen sulfide (H₂S) from the pretreated PW stream;
producing hydrogen (H₂), water (H₂O), and sulfur(S), from the removed H₂S, by an electrolysis cell or a fuel cell; and
producing bromine gas (Br₂) by an electrochemical oxidation process.

19. The method of claim 17, wherein producing a plurality of minerals comprises producing calcium, strontium, lithium, and magnesium.

20. The method of claim 17, wherein producing a plurality of chemicals from the reject stream comprises producing sodium hydroxide (NaOH), hydrochloric acid (HCl), and chlorine gas (Cl₂) by an electrolyzer.
